(19) United States
(12) Patent Application Publication
(10) Pub. No.: US 2025/0362540 A1
(43) Pub. Date: Nov. 27, 2025

(54) LIQUID CRYSTAL ELEMENT

(71) Applicant: Japan Display Inc., Tokyo (JP)

(72) Inventors: Shunichi KIMURA, Tokyo (JP); Toshiharu MATSUSHIMA, Tokyo (JP)

(21) Appl. No.: 19/211,757

(22) Filed: May 19, 2025

(30) Foreign Application Priority Data
May 22, 2024 (JP) 2024-083193

(51) Int. Cl. G02F 1/1335; G02F 1/1333; G02F 1/1343

(52) U.S. Cl. CPC G02F 1/133512; G02F 1/133368; G02F 1/134336

(57) ABSTRACT

A liquid crystal element includes first electrode sets disposed on a first substrate and each including a first electrode and a second electrode, second electrode sets disposed on a second substrate and each including a third electrode and a fourth electrode, a liquid crystal layer between the first and second substrates, and light-shielding films. The first and second electrodes in each first electrode set extend in a first direction and face each other in a second direction. The first electrode sets and the second electrode sets are arranged in the second direction. The first electrode included in one first electrode set overlaps the third electrode included in one second electrode set. The second electrode included in the one first electrode set overlaps the fourth electrode included in the one second electrode set. Each light-shielding film overlaps a gap between two first electrode sets adjacent in the second direction.

### CROSS-REFERENCE TO RELATED APPLICATION

This application claims the benefit of priority from Japanese Patent Application No. 2024-083193 filed on May 22, 2024, the entire contents of which are incorporated herein by reference.

### BACKGROUND

### 1. Technical Field

What is disclosed herein relates to a liquid crystal element.

### 2. Description of the Related Art

Japanese Patent Application Laid-open Publication No. 2015-174551 (JP-A-2015-174551) discloses a headlight capable of controlling light distribution. The headlight of JP-A-2015-174551 reflects light from a light source by using a mirror, converges the reflected light with a lens, and projects light toward the front of the vehicle. The direction of light projection is adjusted by adjusting the angle of the mirror.

Japanese Patent Application Laid-open Publication No. 2023-63255 (JP-A-2023-63255) discloses an illumination device including a lamp unit including a light source, and an arm coupled to the lamp unit. The arm includes a first arm and a second arm coupled to each other in a relatively rotatable manner. The lamp unit and the second arm are coupled to each other in a relatively rotatable manner. The emission direction of light from the light source is adjusted by adjusting the angle between the first and second arms and the angle between the lamp unit and the second arm.

In a device capable of adjusting the emission direction of light as in JP-A-2015-174551 or JP-A-2023-63255, the emission direction of light is adjusted through operation of a movable part in a mechanism including a plurality of mechanical components. The configuration of such a device is desired to be simplified.

For the foregoing reasons, there is a need for a liquid crystal element capable of easily adjusting the emission direction of light.

### SUMMARY

According to an aspect, a liquid crystal element includes: a first substrate and a second substrate facing each other; a plurality of first electrode sets disposed on the first substrate and each including a first electrode and a second electrode; a plurality of second electrode sets disposed on the second substrate and each including a third electrode and a fourth electrode; a liquid crystal layer positioned between the first substrate and the second substrate; and a plurality of light-shielding films that interrupt light transmission. The first electrode and the second electrode in each of the first electrode sets extend in a first direction and face each other in a second direction orthogonal to the first direction. The first electrode sets and the second electrode sets are arranged in the second direction. The first electrode included in one of the first electrode sets overlaps the third electrode included in one of the second electrode sets in plan view. The second electrode included in the one first electrode set overlaps the fourth electrode included in the one second electrode set. Each of the light-shielding films overlaps a gap between two first electrode sets adjacent to each other in the second direction among the first electrode sets in plan view.

### BRIEF DESCRIPTION OF THE DRAWINGS

FIG. 1 is a conceptual diagram of a liquid crystal element according to an embodiment of the present disclosure;

FIG. 2 is a plan view of the liquid crystal element according to the embodiment of the present disclosure;

FIG. 3 is a sectional view of the liquid crystal element along line III-III illustrated in FIG. 2;

FIG. 4 is a plan view illustrating an arrangement of first electrode sets;

FIG. 5 is a plan view illustrating an arrangement of second electrode sets;

FIG. 6 is a diagram illustrating the tilt degree of liquid crystal molecules when the liquid crystal element refracts emission light in a fourth direction;

FIG. 7 is a diagram illustrating the phase difference of emission light passing through a liquid crystal layer of the liquid crystal element illustrated in FIG. 6;

FIG. 8 is a sectional view of a liquid crystal element of a comparative example; and

FIG. 9 is a diagram illustrating the tilt degrees of liquid crystal molecules when the liquid crystal element of the comparative example refracts emission light in the fourth direction.

### DETAILED DESCRIPTION

An embodiment of the present disclosure is described below with reference to the drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the present disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

A first direction D1 and a second direction D2 illustrated in the drawings correspond to directions parallel to the plate surfaces of substrates included in a liquid crystal element 1 to be described later. The first direction D1 and the second direction D2 correspond to sides of the liquid crystal element 1. In the first direction D1, a side indicated by an arrow is a positive D1 side, and a side opposite to the positive D1 side is a negative D1 side. In the second direction D2, a side indicated by an arrow is a positive D2 side, and a side opposite to the positive D2 side is a negative D2 side.

A third direction D3 corresponds to the thickness direction of the liquid crystal element 1. In the third direction D3, a side indicated by an arrow is a positive D3 side, and a side opposite to the positive D3 side is a negative D3 side. The positive D3 side in the third direction D3 corresponds to the front surface side of the liquid crystal element 1, and the negative D3 side in the third direction D3 corresponds to the back surface side of the liquid crystal element 1. In the present specification, “plan view” is a view when the liquid crystal element 1 is viewed in the third direction D3. The first direction D1, the second direction D2, and the third direction D3 are exemplary, and the present disclosure is not limited to these directions.

In this disclosure, when an element is described as being “on” another element, the element can be directly on the other element, or there can be one or more elements between the element and the other element.

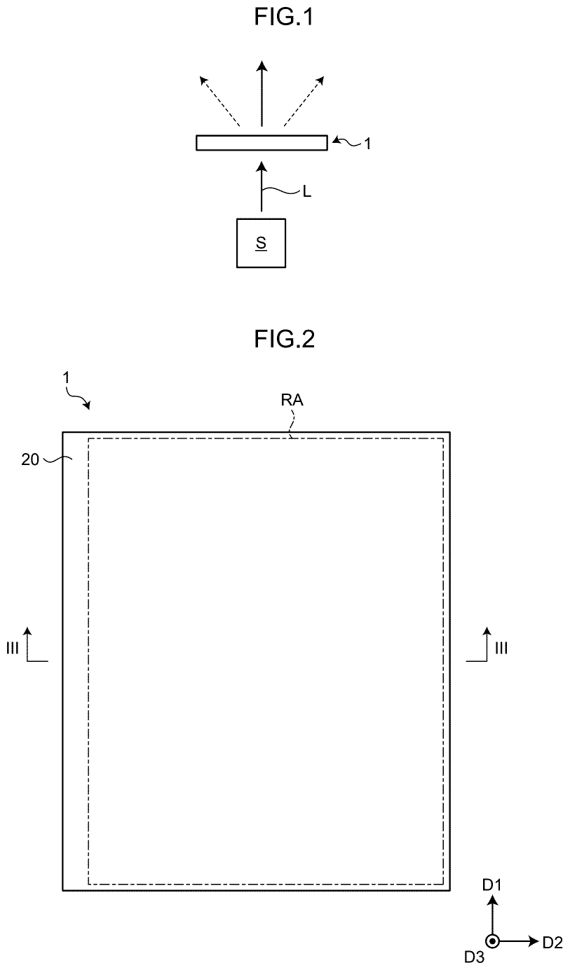

FIG. 1 is a conceptual diagram of the liquid crystal element 1 according to an embodiment of the present disclosure. The liquid crystal element 1 is a refractive plate that refracts light. Emission light L emitted from a light source S enters the liquid crystal element 1. The light source S is, for example, an illumination device such as a vehicle headlight or a spotlight.

When no voltage is applied, the liquid crystal element 1 transmits the emission light L as illustrated with the solid arrow without changing the direction (emission direction) in which the emission light L travels. When voltage is applied, the liquid crystal element 1 refracts the emission light L in one of two directions illustrated with the dashed arrows (to be described later in detail).

FIG. 2 is a plan view of the liquid crystal element 1 according to the embodiment of the present disclosure.

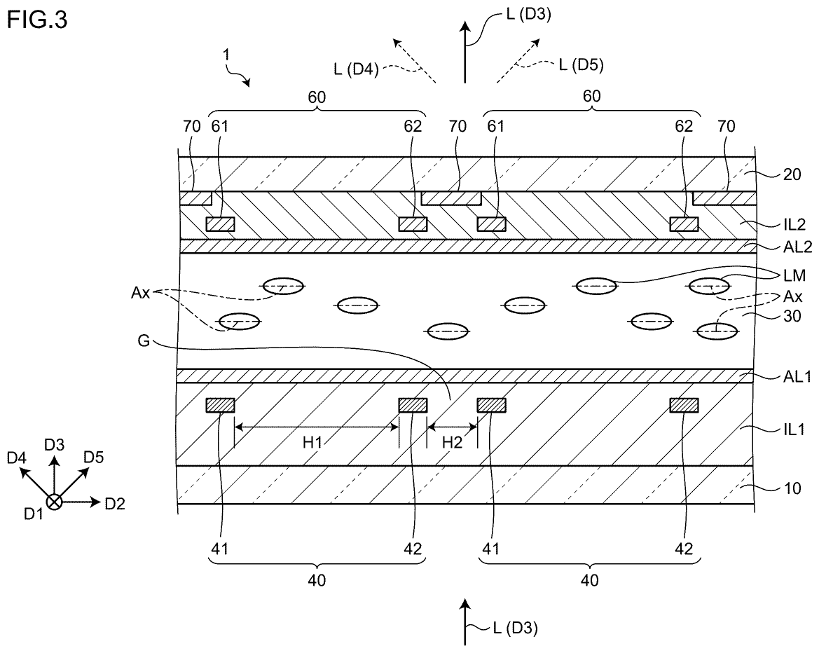

FIG. 3 is a sectional view of the liquid crystal element 1 along line III-III illustrated in FIG. 2. The sectional view of the liquid crystal element 1 illustrated in FIG. 3 illustrates a sectional shape of the liquid crystal element 1 along a plane orthogonal to the first direction D1.

The liquid crystal element 1 includes a first substrate 10, a second substrate 20, and a liquid crystal layer 30.

The first substrate 10 and the second substrate 20 face each other. The first substrate 10 and the second substrate 20 have a light-transmitting property. The first substrate 10 and the second substrate 20 are, for example, glass substrates, resin substrates, or resin films.

A plurality of first electrode sets 40, a first insulating layer IL1, and a first alignment film AL1 are disposed on the first substrate 10. Each first electrode set 40 includes a first electrode 41 and a second electrode 42.

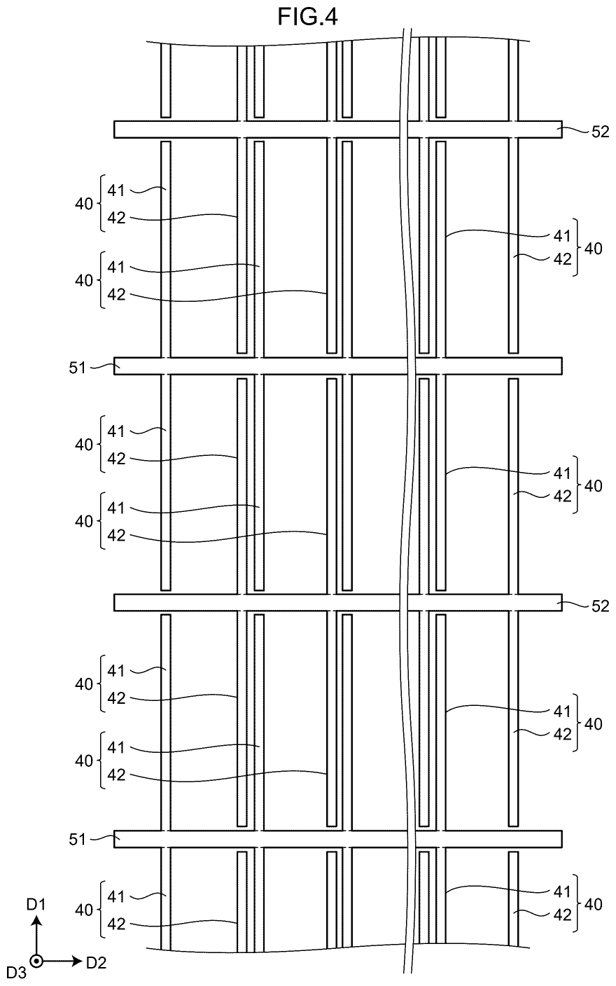

FIG. 4 is a plan view illustrating an arrangement of the first electrode sets 40. The first electrode sets 40 are arranged in a matrix having a row-column configuration in the first direction D1 and the second direction D2.

The first electrodes 41 and the second electrodes 42 extend in the first direction D1. In each first electrode set 40, the first electrode 41 and the second electrode 42 face each other in the second direction D2. In the present embodiment, in each first electrode set 40, the first electrode 41 is positioned on the negative D2 side relative to the second electrode 42. The first electrode 41 may be positioned on the positive D2 side relative to the second electrode 42.

Since the first electrode sets 40 are disposed as described above, the first electrodes 41 are arranged in a line in the first direction D1, the second electrodes 42 are arranged in a line in the first direction D1, and the first electrodes 41 and the second electrodes 42 are alternately arranged in the second direction D2.

As illustrated in FIG. 3, the length in the second direction D2 between the first electrode 41 and the second electrode 42 included in one first electrode set 40 is defined as a first length H1. The length between two first electrode sets 40 adjacent to each other in the second direction D2 among the first electrode sets 40 is defined as a second length H2. Specifically, the second length H2 is the length in the second direction D2 between the first electrode 41 of one of the two first electrode sets 40 adjacent to each other in the second direction D2 and the second electrode 42 of the other of the two first electrode sets 40, wherein the first electrode 41 and the second electrode 42 face each other in the second direction D2. The first length H1 is larger than the second length H2.

As illustrated in FIG. 4, the liquid crystal element 1 further includes a plurality of first trunk electrodes 51 and a plurality of second trunk electrodes 52 disposed on the first substrate 10.

The first trunk electrodes 51 extend in the second direction D2. The first trunk electrodes 51 are each positioned between two second electrodes 42 adjacent to each other in the first direction D1. The first trunk electrodes 51 are separated from the second electrodes 42 in plan view. The first trunk electrodes 51 are arranged in the first direction D1.

Each first trunk electrode 51 is electrically coupled to more than one of the first electrodes 41. The first trunk electrode 51 is integrated with the more than one of the first electrodes 41. The more than one of the first electrodes 41 are electrically coupled to the first trunk electrode 51 such that they protrude from the first trunk electrode 51 toward both sides in the first direction D1.

The second trunk electrodes 52 extend in the second direction D2. The second trunk electrodes 52 are each positioned between two first electrodes 41 adjacent to each other in the first direction D1. The second trunk electrodes 52 are separated from the first electrodes 41 in plan view. The second trunk electrodes 52 are arranged in the first direction D1. The first and second trunk electrodes 51 and 52 are alternately arranged in the first direction D1.

Each second trunk electrode 52 is electrically coupled to more than one of the second electrodes 42. The second trunk electrode 52 is integrated with the more than one of the second electrodes 42. The more than one of the second electrodes 42 are electrically coupled to the second trunk electrode 52 such that they protrude from the second trunk electrode 52 toward both sides in the first direction D1.

The material of the first electrodes 41, the second electrodes 42, the first trunk electrodes 51, and the second trunk electrodes 52 is a conductive material such as molybdenum tungsten alloy (MOW) or TAT (Ti/Al/Ti) in which titanium (Ti) and aluminum (Al) are stacked.

The first and second trunk electrodes 51 and 52 are electrically coupled to a non-illustrated control circuit. The control circuit applies voltage to the first electrodes 41 through the first trunk electrodes 51. The control circuit applies voltage to the second electrodes 42 through the second trunk electrodes 52.

The first insulating layer IL1 illustrated in FIG. 3 electrically insulates the first trunk electrodes 51 and the second trunk electrodes 52 from each other. The first insulating layer IL1 also electrically insulates the first electrodes 41 and the second electrodes 42 from each other.

The first alignment film AL1 is disposed on the front surface side of the first electrode 41 and the second electrode 42. The first alignment film AL1 is disposed in a state of being separated from the first electrode 41 and the second electrode 42. The first alignment film AL1 may contact the first electrodes 41 and the second electrodes 42.

A plurality of second electrode sets 60, a second insulating layer IL2, a plurality of light-shielding films 70, and a second alignment film AL2 are disposed on the second substrate 20. Each second electrode set 60 includes a third electrode 61 and a fourth electrode 62.

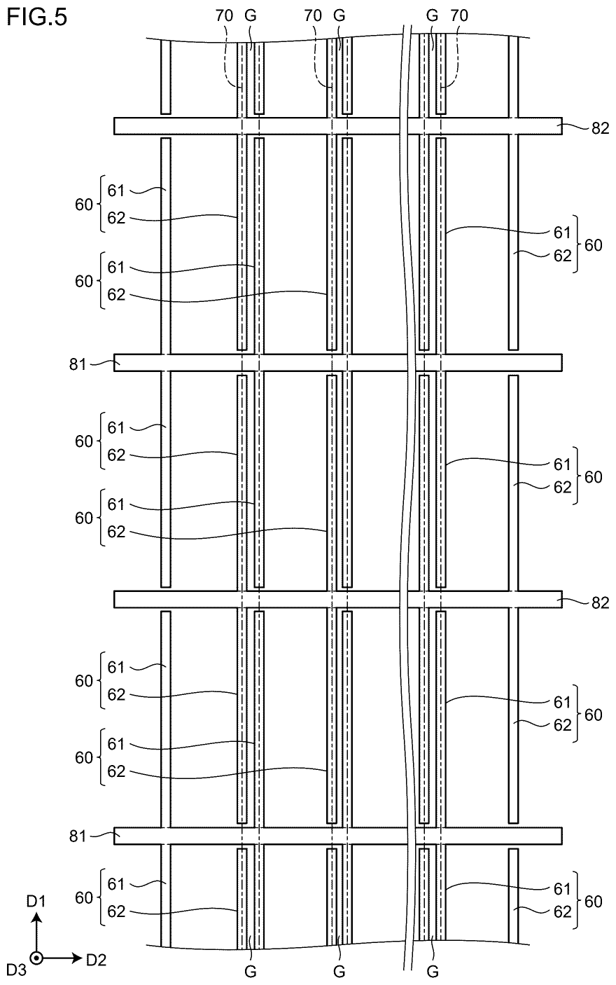

FIG. 5 is a plan view illustrating an arrangement of the second electrode sets 60. The second electrode sets 60 are arranged in a matrix having a row-column configuration in the first direction D1 and in the second direction D2. The second electrode sets 60 face the first electrode sets 40 in the third direction D3.

The third electrodes 61 and the fourth electrodes 62 extend in the first direction D1. In each second electrode set 60, the third electrode 61 and the fourth electrode 62 face each other in the second direction D2. In the present embodiment, in each second electrode set 60, the third electrode 61 is positioned on the negative D2 side relative to the fourth electrode 62.

Since the second electrode sets 60 are disposed as described above, the third electrodes 61 are arranged in a line in the first direction D1, the fourth electrodes 62 are arranged in the first direction D1, and the third electrodes 61 and the fourth electrodes 62 are alternately arranged in the second direction D2. In plan view, the first electrode sets 40 and the second electrode sets 60 overlap a refraction region RA (refer to FIG. 2) in which the emission light L is refracted.

As illustrated in FIG. 3, the third electrode 61 overlap the first electrode 41 in plan view. The fourth electrodes 62 overlap the second electrodes 42 in plan view. Specifically, the first electrode 41 included in one of the first electrode sets 40 overlaps the third electrode 61 included in one of the second electrode sets 60 in plan view, and the second electrode 42 included in the one first electrode set 40 overlaps the fourth electrode 62 included in the one second electrode sets 60. The third electrode 61 may partially overlap the first electrode 41 in plan view. The fourth electrode 62 may partially overlap the second electrode 42 in plan view.

As illustrated in FIG. 5, the liquid crystal element 1 further includes a plurality of third trunk electrodes 81 and a plurality of fourth trunk electrodes 82 disposed on the second substrate 20.

The third trunk electrodes 81 extend in the second direction D2. The third trunk electrodes 81 are each positioned between two fourth electrodes 62 adjacent to each other in the first direction D1. The third trunk electrodes 81 are separated from the fourth electrodes 62 in plan view. The third trunk electrodes 81 are arranged in the first direction D1. The third trunk electrodes 81 overlap the first trunk electrodes 51 in plan view.

Each third trunk electrode 81 is electrically coupled to more than one of the third electrodes 61. The more than one of the third trunk electrode 81 is integrated with the third electrodes 61. The more than one of the third electrodes 61 are electrically coupled to the third trunk electrode 81 such that they protrude from the third trunk electrode 81 toward both sides in the first direction D1.

The fourth trunk electrodes 82 extend in the second direction D2. The fourth trunk electrodes 82 are each positioned between two third electrodes 61 adjacent to each other in the first direction D1. The fourth trunk electrodes 82 are separated from the third electrodes 61 in plan view. The fourth trunk electrodes 82 are arranged in the first direction D1. The third and fourth trunk electrodes 81 and 82 are alternately arranged in the first direction D1. The fourth trunk electrodes 82 overlap the second trunk electrodes 52 in plan view.

Each fourth trunk electrode 82 is electrically coupled to more than one of the fourth electrodes 62. The more than one of the fourth trunk electrode 82 is integrated with the fourth electrodes 62. The more than one of the fourth electrodes 62 are electrically coupled to the fourth trunk electrode 82 such that they protrude from the fourth trunk electrode 82 toward both sides in the first direction D1.

The material of the third electrodes 61, the fourth electrodes 62, the third trunk electrodes 81, and the fourth trunk electrodes 82 is a conductive material having a light-transmitting property, such as indium tin oxide (ITO), indium zinc oxide (IZO), indium gallium oxide (IGO), or indium gallium zinc oxide (IGZO). The material of the third electrodes 61, the fourth electrodes 62, the third trunk electrodes 81, and the fourth trunk electrodes 82 may be a conductive material such as molybdenum tungsten alloy (MoW) or TAT (Ti/Al/Ti) in which titanium (Ti) and aluminum (Al) are stacked.

The third and fourth trunk electrodes 81 and 82 are electrically coupled to a non-illustrated control circuit. The control circuit applies voltage to the third electrodes 61 through the third trunk electrodes 81. The control circuit applies voltage to the fourth electrodes 62 through the fourth trunk electrodes 82.

The second insulating layer IL2 illustrated in FIG. 3 electrically insulates the third trunk electrodes 81 and the fourth trunk electrodes 82 from each other. The second insulating layer IL2 also electrically insulates the third electrodes 61 and the fourth electrodes 62 from each other.

The second alignment film AL2 is disposed on the back surface side of each of the third electrodes 61 and the fourth electrodes 62. The second alignment film AL2 is disposed in a state of being separated from the third electrodes 61 and the fourth electrodes 62. The second alignment film AL2 may contact the third electrodes 61 and the fourth electrodes 62.

The light-shielding films 70 interrupt light transmission. The light-shielding films 70 have conductivity. The material of the light-shielding film 70 is, for example, molybdenum tungsten alloy (MoW). The light-shielding films 70 are positioned between the second substrate 20 and the second insulating layer IL2. Each of the light-shielding films 70 overlaps a gap G between two first electrode sets 40 adjacent to each other in the second direction D2 in plan view.

In FIG. 5, the light-shielding films 70 are illustrated with dashed and single-dotted lines. The light-shielding films 70 each have a strip shape extending in the first direction D1.

The liquid crystal layer 30 illustrated in FIG. 3 is positioned between the first substrate 10 and the second substrate 20. The liquid crystal layer 30 is sandwiched between the first alignment film AL1 and the second alignment film AL2. The first alignment film AL1 and the second alignment film AL2 define the alignment (initial orientation) of liquid crystal molecules LM contained in the liquid crystal layer 30 when no voltage is applied to the liquid crystal element 1. The initial orientation of the liquid crystal molecules LM is in such an orientation (horizontal orientation) that a long axis Ax of each liquid crystal molecule LM is orthogonal to the third direction

D3. The alignment direction of the first alignment film AL1 and the alignment direction of the second alignment film AL2 are parallel to each other in plan view. The liquid crystal element 1 is an electrically controlled birefringence (ECB) liquid crystal element. However, the liquid crystal element 1 is not limited to an ECB liquid crystal element.

The following describes operation when the liquid crystal element 1 refracts the emission light L from the light source S. The liquid crystal element 1 refracts the emission light L when voltage is applied to the first electrodes 41, the second electrodes 42, the third electrodes 61, and the fourth electrodes 62 by a control circuit. The emission light L enters the liquid crystal element 1 in the third direction D3 from the back surface of the first substrate 10. A reference sign inside parentheses given to the emission light L indicates the direction in which the emission light L travels. In FIG. 3, the emission light L from the liquid crystal element 1 is illustrated on the positive D3 side of the liquid crystal element 1.

When no voltage is applied to the first electrodes 41, the second electrodes 42, the third electrodes 61, and the fourth electrodes 62, the alignment states of all liquid crystal molecules LM included in the liquid crystal layer 30 are in initial orientation (horizontal orientation) and all liquid crystal molecules LM have the same tilt degree. Thus, the phase change amount of the emission light L passing through the liquid crystal layer 30 is equal at all portions of the liquid crystal layer 30, and no phase difference occurs to the emission light L. Accordingly, the liquid crystal element 1 allows the emission light L to exit therefrom without refraction. Specifically, as illustrated in FIG. 3, when the emission light L enters the liquid crystal element 1 along the third direction D3, the liquid crystal element 1 allows the emission light L to exit therefrom along the third direction D3 without refraction.

When the liquid crystal element 1 refracts the emission light L from the light source S, voltage is applied to the first electrodes 41, the second electrodes 42, the third electrodes 61, and the fourth electrodes 62 such that the magnitude of a first potential difference between the potential of the first electrodes 41 and the potential of the third electrodes 61 is different from the magnitude of a second potential difference between the potential of the second electrodes 42 and the potential of the fourth electrodes 62. Hereinafter, the first electrodes 41, the second electrodes 42, the third electrodes 61, and the fourth electrodes 62 are simply referred to as “electrodes” when described without distinction.

Specifically, when the liquid crystal element 1 refracts the emission light L so that the light travels in a fourth direction D4 tilted to the negative D2 side relative to the third direction D3, voltage is applied to the electrodes such that the magnitude of the second potential difference is larger than the magnitude of the first potential difference.

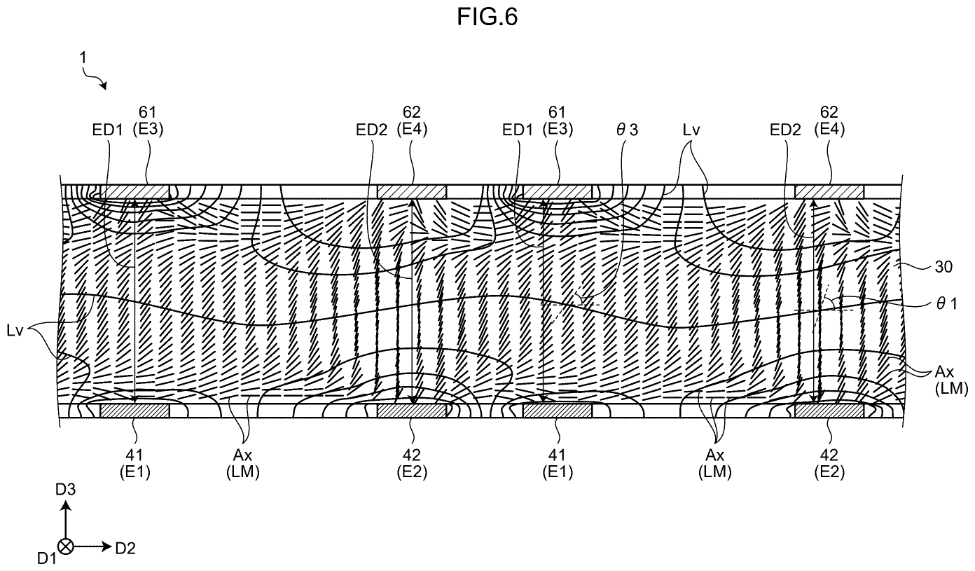

FIG. 6 is a diagram illustrating the tilt degree of the liquid crystal molecules LM when the liquid crystal element 1 refracts the emission light L in the fourth direction D4. In FIG. 6, the liquid crystal molecules LM are represented only by the long axes Ax of the liquid crystal molecules LM. Potential lines Lv of an electric field and the like generated in the liquid crystal layer 30 are illustrated in FIG. 6. The initial orientation of the liquid crystal molecules LM is horizontal orientation as described above. Accordingly, when no voltage is applied to the electrodes, the long axes Ax of the liquid crystal molecules LM align with the second direction D2.

When voltage is applied to the electrodes, an electric field acts on the liquid crystal layer 30, causing the liquid crystal molecules LM to tilt. As the magnitude of the potential difference in the third direction D3 increases in the liquid crystal layer 30, the tilt degree of the liquid crystal molecules LM increases (the angles of the long axes Ax of the liquid crystal molecules LM relative to the second direction D2 increase).

As the tilt degree of the liquid crystal molecules LM increases, the phase of the emission light L passing through the liquid crystal layer 30 advances. In other words, as the magnitude of the potential difference in the third direction D3 in the liquid crystal layer 30 increases, the phase of the emission light L advances.

FIG. 6 illustrates a state in which voltage is applied to the electrodes such that the magnitude (ED2) of the second potential difference between the second electrodes 42 and the fourth electrodes 62 becomes larger than the magnitude (ED1) of the first potential difference between the first electrodes 41 and the third electrodes 61 (ED1<ED2). Accordingly, in FIG. 6, the tilt degree of the liquid crystal molecules LM between the second and fourth electrodes 42 and 62 is larger than the tilt degree of the liquid crystal molecules LM between the first and third electrodes 41 and 61. From the first electrodes 41 toward the second electrodes 42 in the second direction D2, the magnitude of the potential difference in the third direction D3 and the tilt degree of the liquid crystal molecules LM increase.

Voltage is applied to the first electrodes 41, the second electrodes 42, the third electrodes 61, and the fourth electrodes 62 such that the potential of the first electrodes 41 is different from the potential of the second electrodes 42 and the potential of the third electrodes 61 is different from the potential of the fourth electrodes 62. Accordingly, potential difference occurs between the potential of the first electrodes 41 and the potential of the second electrodes 42. Potential difference occurs between the potential of the third electrodes 61 and the potential of the fourth electrodes 62.

In the state illustrated in FIG. 6, voltage is applied to the electrodes such that the potential (E2) of the second electrodes 42 is larger than the potential (E1) of the first electrodes 41 (E1<E2) and the potential (E3) of the third electrodes 61 is larger than the potential (E4) of the fourth electrodes 62 (E4<E3).

In FIG. 6, the potential (E3) of the third electrodes 61 is larger than the potential (E1) of the first electrodes 41 (E1<E3), the potential (E1) of the first electrodes 41 is larger than the potential (E4) of the fourth electrodes 62 (E4<E1), and the potential (E2) of the second electrodes 42 is equal to the potential (E3) of the third electrodes 61 (E2=E3). Thus, the electrode potential relation in FIG. 6 is expressed by Expression (1) below.

$$E 4 < E 1 < E 2 = E 3 \qquad ( 1 )$$

Moreover, in FIG. 6, the potential (E2) of the second electrodes 42 and the potential (E4) of the fourth electrodes 62 have the same magnitude but opposite polarities as expressed by Expression (2).

$$E 2 = ( - 1 ) \times E 4 \qquad ( 2 )$$

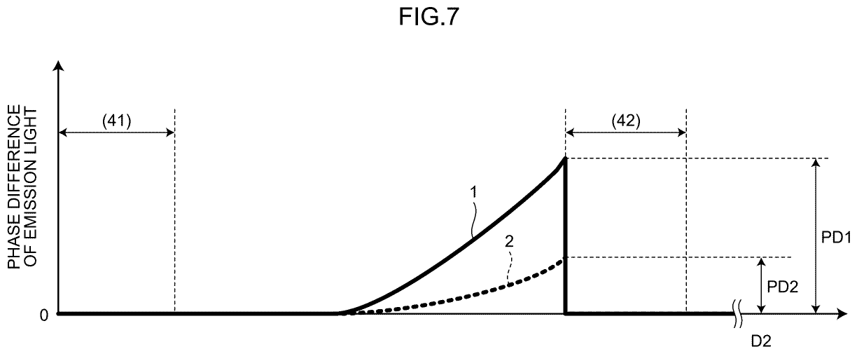

When the electrode potential relation satisfies the relation of Expressions (1) and (2), the electrode potential can be controlled by a column inversion driving method in which the polarity of the electrode potential is periodically inverted. The electrode potential relation is not limited to the relation of Expressions (1) and (2). FIG. 7 is a diagram illustrating the phase difference of the emission light L passing through the liquid crystal layer 30 of the liquid crystal element 1 illustrated in FIG. 6. FIG. 7 illustrates a case where the electrode potential relation is the relation represented by Expressions (1) and (2) and voltage is applied to the electrodes such that the magnitude (ED2) of the second potential difference is twice the magnitude (ED1) of the first potential difference. The vertical axis in FIG. 7 represents the phase difference of the emission light L. The horizontal axis in FIG. 7 represents the position in the second direction D2 in the liquid crystal layer 30. In

FIG. 7, the portion of “(41)” represents the region of a first electrode 41 in the second direction D2, and the portion of “(42)” represents the region of a second electrode 42 in the second direction D2. FIG. 7 illustrates, with a solid line, the phase difference of the emission light L passing through the liquid crystal layer 30 in the liquid crystal element 1 when the phase of the emission light L passing between the first electrode 41 and the corresponding third electrode 61 is regarded as a reference (zero).

As illustrated in FIG. 7, since the magnitude of the second potential difference is larger than the magnitude of the first potential difference (ED1<ED2), the phase difference increases from the first electrode 41 toward the positive D2 side between the first electrode 41 and the second electrode 42. In other words, the phase of the emission light L passing through the liquid crystal layer 30 advances from the first electrode 41 toward the positive D2 side between the first electrode 41 and the second electrode 42. Accordingly, the emission light L is refracted to be emitted in the fourth direction D4.

In a case where the liquid crystal element 1 refracts the emission light L to travel in a fifth direction D5 tilted to the positive D2 side relative to the third direction D3, voltage is applied to the electrodes such that the magnitude of the first potential difference is larger than the magnitude of the second potential difference (ED2<ED1). In this case, voltage is applied to the first electrodes 41, the second electrodes 42, the third electrodes 61, and the fourth electrodes 62 such that the potential of the first electrodes 41 is different from the potential of the second electrodes 42 and the potential of the third electrodes 61 is different from the potential of the fourth electrodes 62. In this case, the electrode potential relation may be the relation represented by Expressions (3) and (4) below.

$$E 3 < E 2 < E 1 = E 4 \qquad ( 3 )$$

$$E 1 = ( - 1 ) \times E 3 \qquad ( 4 )$$

When the electrode potential relation satisfies the relation of Expressions (3) and (4), the electrode potential can be controlled by the column inversion driving method in which the polarity of the electrode potential is periodically inverted. The electrode potential relation is not limited to the relation of Expressions (3) and (4).

Since the magnitude of the first potential difference is larger than the magnitude of the second potential difference, the phase difference in the third direction D3 increases from the second electrode 42 toward the negative D2 side between the first electrode 41 and the second electrode 42. In other words, the phase of the emission light L passing through the liquid crystal layer 30 advances from the second electrode 42 toward the negative D2 side between the first electrode 41 and the second electrode 42. Accordingly, the emission light L is refracted to be emitted in the fifth direction D5.

In this manner, the liquid crystal element 1 can easily adjust the emission direction of the emission light L by controlling voltage applied to the electrodes.

The following describes the configuration of a liquid crystal element 2 of a comparative example.

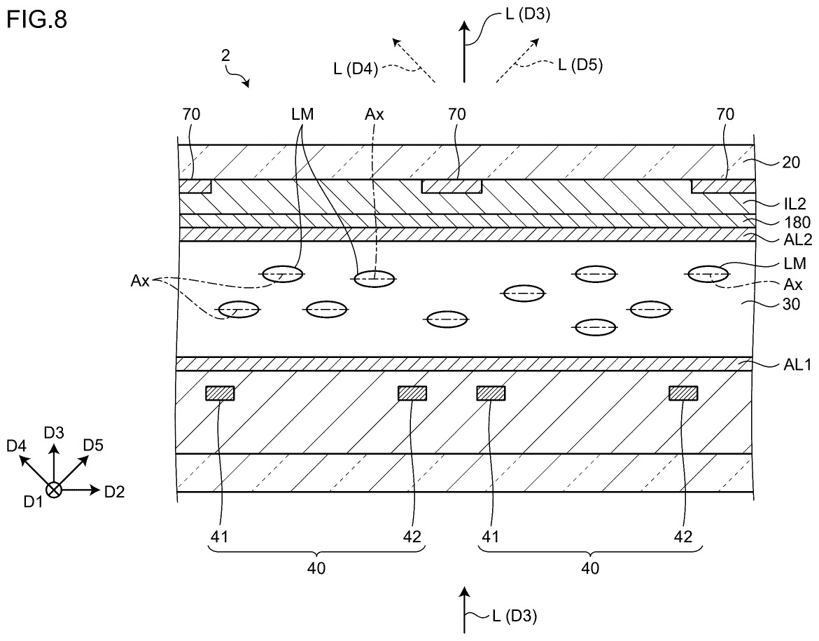

FIG. 8 is a sectional view of the liquid crystal element 2 of the comparative example. The liquid crystal element 2 of the comparative example differs from the above-described liquid crystal element 1 in that the liquid crystal element 2 of the comparative example does not include the third electrodes 61 and the fourth electrodes 62 but includes a fifth electrode 180.

The fifth electrode 180 is disposed between the second substrate 20 and the second alignment film AL2 and overlaps the first electrode sets 40 in plan view.

When the liquid crystal element 2 of the comparative example refracts the emission light L from the light source S, voltage is applied to the first electrodes 41, the second electrodes 42, and the fifth electrode 180 such that the magnitude of a third potential difference between the potential of the first electrodes 41 and the potential of the fifth electrode 180 is different from the magnitude of a fourth potential difference between the potential of the second electrodes 42 and the potential of the fifth electrode 180. In other words, voltage is applied to the electrodes such that the potential of the first electrodes 41 is different from the potential of the second electrodes 42.

For example, when the liquid crystal element 2 of the comparative example refracts the emission light L to travel in the fifth direction D5, voltage is applied to the electrodes such that the magnitude of the third potential difference is larger than the magnitude of the fourth potential difference.

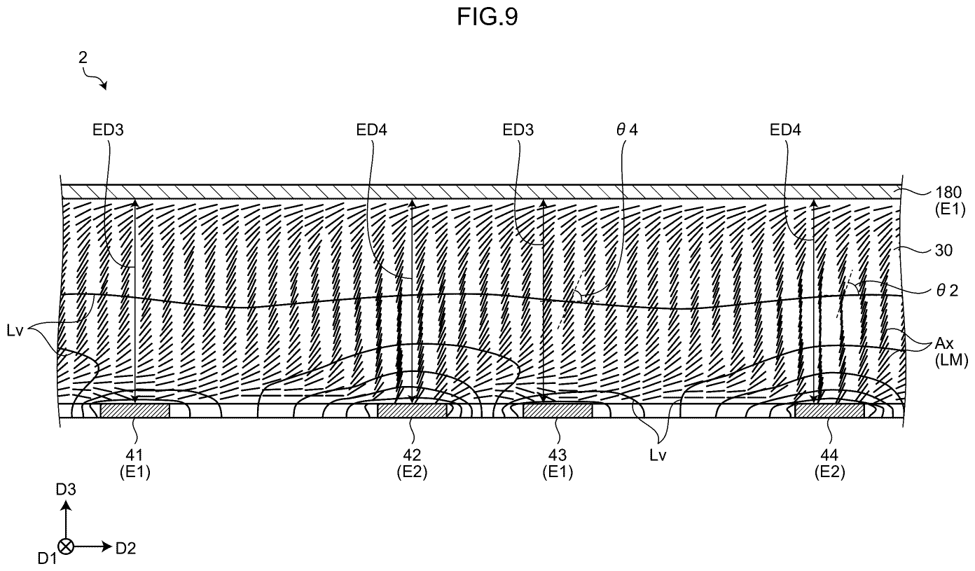

FIG. 9 is a diagram illustrating the tilt degree of the liquid crystal molecules LM when the liquid crystal element 2 of the comparative example refracts the emission light L in the fourth direction D4. In FIG. 9, the potential of the first electrodes 41 is equal to the potential (E1) of the first electrodes 41 illustrated in FIG. 6, and the potential of the second electrodes 42 is equal to the potential (E2) of the second electrodes 42 illustrated in FIG. 6. Accordingly, in FIG. 9, the potential of the second electrodes 42 is larger than the potential of the first electrodes 41. In FIG. 9, the potential of the fifth electrode 180 is equal to the potential (E1) of the first electrodes 41. Accordingly, the magnitude (ED4 (=|E2−E1|)) of the fourth potential difference is larger than the magnitude (ED3 (=|E1−E1 |)) of the third potential difference (ED4>ED3).

The following describes comparison between the above-described liquid crystal element 1 illustrated in FIG. 6 and the liquid crystal element 2 of the comparative example illustrated in FIG. 9. The potential (E1) of the first electrodes 41 and the potential (E2) of the second electrodes 42 in the above-described liquid crystal element 1 are respectively equal to the potential (E1) of the first electrodes 41 and the potential (E2) of the second electrodes 42 in the liquid crystal element 2 of the comparative example.

The magnitude (ED2 (=|E2−E4 |)) of the second potential difference in the above-described liquid crystal element 1 is larger than the magnitude (ED4 (=|E2−E1 |)) of the fourth potential difference in the liquid crystal element 2 of the comparative example (ED2>ED4). Accordingly, the tilt degree (θ1; FIG. 6) of the liquid crystal molecules LM between the second and fourth electrodes 42 and 62 in the above-described liquid crystal element 1 is larger than the tilt degree (θ2; FIG. 9) of the liquid crystal molecules LM between the second and fifth electrodes 42 and 180 in the liquid crystal element 2 of the comparative example (θ1>θ2).

Moreover, in the above-described liquid crystal element 1, potential difference in the second direction D2 occurs between the third and fourth electrodes 61 and 62 adjacent to each other since the potential (E3) of the third electrode 61 is different from the potential (E4) of the fourth electrode 62. This potential difference acts on the liquid crystal molecules LM positioned between the first and third electrodes 41 and 61 to decrease the tilt degree (θ3; FIG. 6) of the liquid crystal molecules LM.

As described above, the liquid crystal element 2 of the comparative example does not include the third electrodes 61 and the fourth electrodes 62 but includes the fifth electrode 180. Thus, no potential difference in the second direction D2 occurs in the vicinity of the fifth electrode 180. Accordingly, the tilt degree (θ3; FIG. 6) of the liquid crystal molecules LM between the first and third electrodes 41 and 61 in the above-described liquid crystal element 1 is smaller than the tilt degree (θ4; FIG. 9) of the liquid crystal molecules LM between the first and fifth electrodes 41 and 180 in the liquid crystal element 2 of the comparative example (θ3<θ4).

FIG. 7 illustrates, with a dashed line, the phase difference of the emission light L passing through the liquid crystal layer 30 in the liquid crystal element 2 of the comparative example illustrated in FIG. 9.

Specifically, FIG. 7 illustrates, with a dashed line, the phase difference of the emission light L passing through the liquid crystal layer 30 in the liquid crystal element 2 of the comparative example when the phase of the emission light L passing between the first and fifth electrodes 41 and 180 is regarded as a reference (zero). In FIG. 7, a part where the solid line illustrating the phase difference of the emission light L in the above-described liquid crystal element 1 overlaps the dashed line illustrating the phase difference of the emission light L in the liquid crystal element 2 of the comparative example is illustrated with a solid line.

Since the tilt degree of the liquid crystal molecules LM has the above-described relation (θ1>θ2 and θ3<θ4) between the above-described liquid crystal element 1 and the liquid crystal element 2 of the comparative example, the tilt degree of the liquid crystal molecules LM between the first electrode 41 and the second electrode 42 has such a difference that the tilt degree difference (θ1−θ3) in the above-described liquid crystal element 1 is larger than the tilt degree difference (θ2−θ4) in the liquid crystal element 2 of the comparative example. Accordingly, as illustrated in FIG. 7, the maximum value (PD1) of the phase difference in the above-described liquid crystal element 1 is larger than the maximum value (PD2) of the phase difference in the liquid crystal element 2 of the comparative example.

As described above, the potential (E1) of the first electrodes 41 and the potential (E2) of the second electrodes 42 in the above-described liquid crystal element 1 are respectively equal to the potential (E1) of the first electrodes 41 and the potential (E2) of the second electrodes 42 in the liquid crystal element 2 of the comparative example. Furthermore, the magnitude (ED1) of the first potential difference between the potential (E1) of the first electrodes 41 and the potential (E3) of the third electrodes 61 in the above-described liquid crystal element 1 is equal to the magnitude (ED4) of the fourth potential difference between the potential of the second electrodes 42 (E2 (=E3)) and the potential of the fifth electrode 180 (E1) in the liquid crystal element 2 of the comparative example. This means that the above-described liquid crystal element 1 can efficiently refract the emission light L as compared to the liquid crystal element 2 of the comparative example.

Preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

For example, voltage may be applied to the electrodes such that the potential of the third electrodes 61 is equal to the potential of the fourth electrodes 62.

The light-shielding films 70 may be disposed on the first substrate 10.

It should be understood that the present disclosure provides any other effects achieved by aspects described above in the above-described embodiments, such as effects that are clear from the description of the present specification or effects that could be thought of by the skilled person in the art as appropriate.

What is claimed is:

1. A liquid crystal element comprising:
a first substrate and a second substrate facing each other;
a plurality of first electrode sets disposed on the first substrate and each including a first electrode and a second electrode;
a plurality of second electrode sets disposed on the second substrate and each including a third electrode and a fourth electrode;
a liquid crystal layer positioned between the first substrate and the second substrate; and
a plurality of light-shielding films that interrupt light transmission, wherein
the first electrode and the second electrode in each of the first electrode sets extend in a first direction and face each other in a second direction orthogonal to the first direction,
the first electrode sets and the second electrode sets are arranged in the second direction,
the first electrode included in one of the first electrode sets overlaps the third electrode included in one of the second electrode sets in plan view,
the second electrode included in the one first electrode set overlaps the fourth electrode included in the one second electrode set, and
each of the light-shielding films overlaps a gap between two first electrode sets adjacent to each other in the second direction among the first electrode sets in plan view.

2. The liquid crystal element according to claim 1, wherein a length in the second direction between the first electrode and the second electrode included in the one first electrode set is larger than a length in the second direction between two first electrode sets adjacent to each other in the second direction among the first electrode sets.

3. The liquid crystal element according to claim 1, wherein voltage is applied to each of the first electrodes, each of the second electrodes, each of the third electrodes, and each of the fourth electrodes such that magnitude of a first potential difference between a potential of the first electrode and a potential of the third electrode is different from magnitude of a second potential difference between a potential of the second electrode and a potential of the fourth electrode.

4. The liquid crystal element according to claim 1, wherein voltage is applied to each of the first electrodes, each of the second electrodes, each of the third electrodes, and each of the fourth electrodes such that a potential of the first electrode is different from a potential of the second electrode and a potential of the third electrode is different from a potential of the fourth electrode.
